(19) United States
(12) Patent Application Publication
(10) Pub. No.: US 2021/0203140 A1
(43) Pub. Date: Jul. 1, 2021

(54) WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventor: Yuichi KIMOTO, Yokkaichi-shi (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 17/057,892

(22) PCT Filed: May 16, 2019
(86) PCT No.: PCT/JP2019/019438

§ 371 Date: Nov. 23, 2020

(30) Foreign Application Priority Data
Jun. 5, 2018 (JP) 2018-107876

(51) Int. Cl. H02G 3/04; H01B 7/00; B60R 16/02

(52) U.S. Cl. CPC H02G 3/0456; B60R 16/0215; H02G 3/0481; H01B 7/0045

(57) ABSTRACT

A wire harness, including: a wire; a route regulator having an axial direction extending along a route where the wire is routed, the route regulator including a holder configured to hold the wire fitted to the holder, and configured to regulate the route where the wire is routed; and an outer cover made of resin and configured to accommodate the wire and the route regulator, the route regulator having a bending rigidity that is higher than a bending rigidity of the outer cover.

### BACKGROUND

The present disclosure relates to a wire harness.

Conventionally, a wire harness for use in a vehicle, such as a hybrid vehicle or an electric vehicle, is known in which a wire is externally covered with an outer cover member made of resin, such as a corrugated tube or a resin pipe (see, for example, JP 2010-51042A and JP 2017-225207A).

### SUMMARY

An outer cover member made of resin has rigidity that is lower than that of an outer cover member made of metal, making it difficult to keep a desired shape thereof in and after routing of the wire harness.

An exemplary aspect of the disclosure provides a wire harness that enables an outer cover member made of resin to keep its desired shape.

A wire harness according to an exemplary aspect includes a wire; a route regulator having an axial direction extending along a route where the wire is routed, the route regulator including a holder configured to hold the wire fitted to the holder, and configured to regulate the route where the wire is routed; and an outer cover made of resin and configured to accommodate the wire and the route regulator, the route regulator having a bending rigidity that is higher than a bending rigidity of the outer cover

The wire harness according to the present disclosure makes it possible to keep an outer cover member made of resin in a desired shape.

### BRIEF DESCRIPTION OF THE DRAWINGS

FIG. 1 is a schematic view of a wire harness according to one embodiment.

FIG. 2 is a schematic sectional view of the wire harness according to the embodiment.

FIG. 3 is a schematic perspective view of the wire harness according to the embodiment.

FIGS. 4(a) and 4(b) are schematic sectional views of the wire harness according to the embodiment.

FIG. 5 is a schematic sectional view of a wire harness according to a modification.

### DETAILED DESCRIPTION OF EMBODIMENTS

The following describes an embodiment of a wire harness with reference to the drawings. Note that, in the drawings, some of the components may be exaggerated or simplified for the sake of description. Also, the dimensional ratio of some parts may differ from their actual ratio.

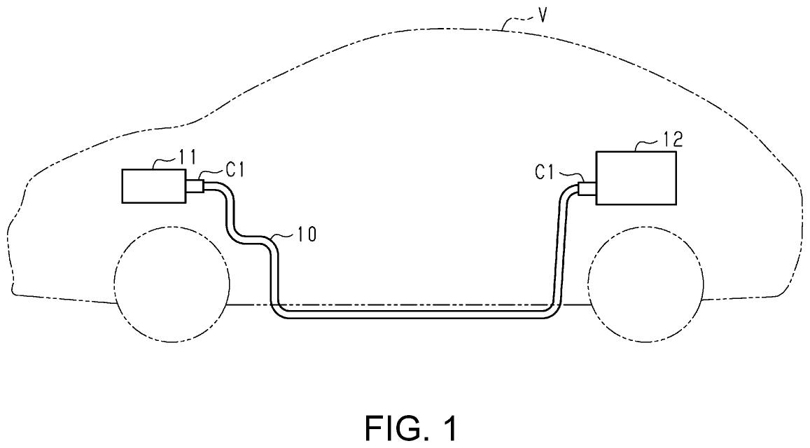

A wire harness 10 shown in FIG. 1 electrically connects two electric apparatuses (devices) or three or more electric apparatuses (devices). For example, the wire harness 10 electrically connects an inverter 11 disposed in a front part of a vehicle V, such as a hybrid vehicle or an electric vehicle, and a high-voltage battery 12 disposed in a part of the vehicle V rearward of the inverter 11. The wire harness 10 is routed under the floor of the vehicle, for example. The inverter 11 is connected to a wheel driving motor (not shown), which is a power source for driving the vehicle. The inverter 11 generates AC power from DC power that is supplied from the high-voltage battery 12, and supplies the AC power to the motor. The high-voltage battery 12 is, for example, a battery that can supply a voltage of several hundred volts.

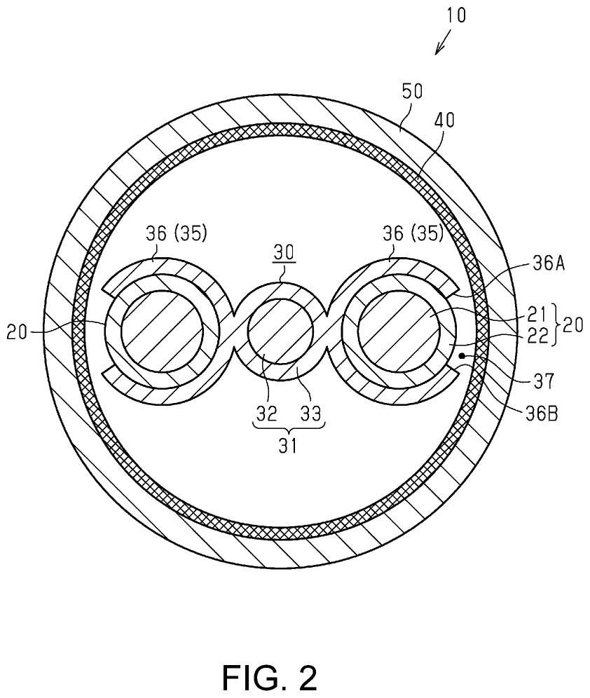

As shown in FIGS. 1 and 2, the wire harness 10 includes a plurality of (two in this embodiment) wires 20, a pair of connectors C1 attached to opposite ends of the wires 20, and a route-regulating member 30 (route regulator) configured to regulate the route where the wires 20 are routed. Moreover, the wire harness 10 also includes an electromagnetic shielding component 40 enclosing the wires 20 collectively, and an outer cover member 50 (outer cover) made of resin, which encloses the wires 20 and the route-regulating member 30.

The wires 20 are, for example, high-voltage wires that can handle high voltages and large currents. Moreover, the wires 20 are non-shielded wires without any shield structure of their own. One end of the wires 20 is connected to the inverter 11 via one of the connectors C1, and the other end of the wires 20 is connected to the high-voltage battery 12 via the other connector C1.

The electromagnetic shielding component 40 shown in FIG. 2 has an overall elongated tubular shape. The electromagnetic shielding component 40 is formed, for example, so as to enclose the wires 20 and the route-regulating member 30 collectively. For example, the electromagnetic shielding component 40 is formed so as to enclose the wires 20 and the route-regulating member 30 collectively over substantially the entire length of the wires 20. The electromagnetic shielding component 40 is disposed in a space inside of the outer cover member 50, for example. The electromagnetic shielding component 40 is flexible, for example, and therefore can be deformed along the wiring routes of the wires 20. The electromagnetic shielding component 40 in this embodiment is a tubular member formed by braiding a plurality of bare metal wires, and thus a flexible braided member. A metallic material such as a copper-based material and an aluminum-based material can be used for the bare metal wires that form the electromagnetic shielding component 40.

The outer cover member 50 is flexible, and therefore can be deformed along the wiring route of the wires 20. The outer cover member 50 protects the wires 20 by covering the wires 20. The outer cover member 50 has an overall elongated tubular shape. The outer cover member 50 encloses the electromagnetic shielding component 40 as well as the wires 20 and the route-regulating member 30 collectively. In other words, the wires 20, the route-regulating member 30, and the electromagnetic shielding component 40 are disposed in the space inside of the outer cover member 50. The outer cover member 50 in this embodiment is formed so as to cover the route-regulating member 30 entirely. That is, the outer cover member 50 in this embodiment is formed so as to cover the entire length of the route-regulating member 30 and the entire circumference of the route-regulating member 30. In other words, the route-regulating member 30 in this embodiment is not exposed to the outside of the outer cover member 50.

A hard resin pipe, a corrugated tube, or a twisted tube can be used for the outer cover member 50, for example. The outer cover member 50 in this embodiment is a hard resin pipe. Synthetic resin such as polyolefin, polyamide, polyester, and an ABS resin can be used for the material of the outer cover member 50.

The wires 20 are coated wires each including a core wire 21 formed by a conductor and an insulating sheath 22 that covers an outer circumference of the core wire 21. The wires 20 are elongated so as to extend in the front-back direction of the vehicle, for example. A stranded wire obtained by twisting together, for example, a plurality of bare metal wires, a single core wire formed by one columnar (e.g., cylindrical) metal rod whose inside is solid, or a tubular conductor (a pipe conductor) whose inside is hollow can be used for the core wire 21. Moreover, combination of a stranded wire, a single core wire and/or a tubular conductor may be used for the core wire 21. A metallic material such as a copper-based material or an aluminum-based material can be used as a material of the core wire 21. The insulating sheath 22 covers, for example, the entire outer circumferential surface of the core wire 21 in a close contact manner (by areal contact). The insulating sheath 22 is made of an insulation material such as synthetic resin, for example. The insulating sheath 22 can be formed through, for example, extrusion molding (extrusion coating) on the core wire 21.

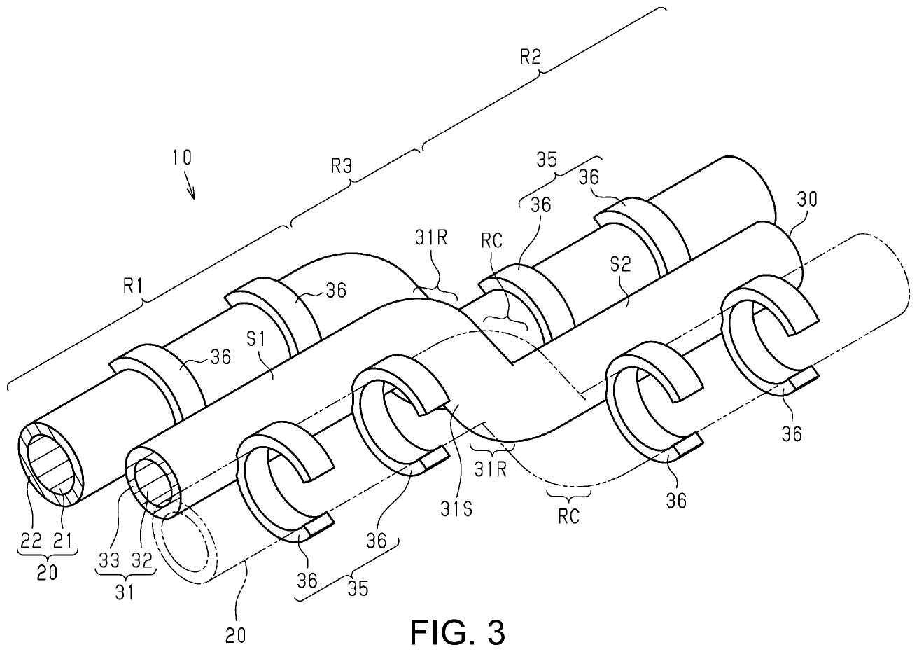

As shown in FIG. 3, the route in which the wires 20 are routed includes a first straight route R1, a second straight route R2, and an intermediate route R3 between the first straight route R1 and the second straight route R2. The intermediate route R3 includes curved routes RC. The intermediate route R3 in this embodiment includes two curved routes RC and a straight route between the two curved routes RC.

The route-regulating member 30 has an axial direction extending along the routes where the wires 20 are routed. The route-regulating member 30 is made elongated and extends along the routes where the wires 20 are routed. The route-regulating member 30 is bent two-dimensionally or three-dimensionally as appropriate in accordance with the routes where the wires 20 are routed, for example.

The route-regulating member 30 is provided so as to hold the wires 20 fitted to it, and regulates the routes where the wires 20 are routed inside the outer cover member 50. Here, a single route-regulating member 30 or a plurality of route-regulating members 30 may be provided. For example, a plurality of sections of the wire 20 may be regulated by one route-regulating member 30, or one section of the wire 20 may be regulated by a plurality of route-regulating members 30. Moreover, the route-regulating member 30 may be formed by a straight portion only, by a bent portion only, or by combination of straight and bent portions. In the wire harness 10 in this embodiment, one route-regulating member 30 regulates three routes (sections), i.e., the first straight route R1, the intermediate route R3, and the second straight route R2 of the wire 20.

Moreover, one route-regulating member 30 may regulate substantially the entire length of the route of the wire 20. In this case, it is preferred that the route-regulating member 30 has a route length that is smaller than that of the wire 20, for example. This makes sure that the route-regulating member 30 does not abut against the connectors C1 provided at the ends of the wires 20, for example.

The route-regulating member 30 has bending rigidity that is higher than that of the outer cover member 50, and thus bends less than the outer cover member 50. The route-regulating member 30 has bending rigidity that is higher than that of the wires 20, for example, and thus bends less than the wires 20.

The route-regulating member 30 includes, for example, an axial portion 31 whose axial direction extends along the routes where the wires 20 are routed, and holders 35 that protrude outward in a direction perpendicular with respect to the axial direction of the axial portion 31 (i.e., in a radial direction) and hold the wires 20 fitted to them.

The axial portion 31 includes, for example, a core portion 32 (core), and a sheath 33 made of resin covering an outer circumference of the core portion 32. The axial portion 31 (the core portion 32 and the sheath 33) in this embodiment has an axial direction extending along the first straight route R1, the intermediate route R3, and the second straight route R2 where the wires 20 are routed. That is, the axial portion 31 in this embodiment includes a straight portion S1 having an axial direction extending along the first straight route R1, a plurality of bent portions 31R and a straight portion 31S each having an axial direction extending along the intermediate route R3, and a straight portion S2 having an axial direction extending along the second straight route R2.

The core portion 32 may be formed in a solid or tubular shape. The core portion 32 in this embodiment is formed in a solid cylindrical shape. The core portion 32 has bending rigidity that is higher than that of the outer cover member 50, and thus bends less than the outer cover member 50. The core portion 32 has bending rigidity that is higher than that of the wires 20, for example, and thus bends less than the wires 20. The core portion 32 is made of a material that has sufficient rigidity to maintain the shape of the outer cover member 50. The core portion 32 is preferably made of a material that is plastically deformable from the viewpoint of making it possible to set the routes through bending processing. For example, a metallic material is favorably used as the material of the core portion 32. A metallic material such as a copper-based material, an iron-based material, or an aluminum-based material can be used as the metallic material. The core portion 32 in this embodiment is made of an aluminum-based metallic material. This reduces the total weight of the route-regulating member 30. For example, when comparing the core portion 32 and the core wire 21 of the wire 20 having a length equal to that of the core portion 32, the core portion 32 is lighter than the core wire 21.

The sheath 33 covers the entire outer circumferential surface of the core portion 32 in a close contact manner (by areal contact), for example. The sheath 33 is formed in a tubular shape. The sheath 33 in this embodiment is formed in a cylindrical shape. The sheath 33 covers the entire length of the core portion 32 in a close contact manner. That is, the sheath 33 covers the entire outer circumferential surface of the core portion 32. In other words, the outer circumferential surface of the core portion 32 is not exposed from the sheath 33. Synthetic resin such as polyolefin, polypropylene, polyamide, polyester, or polyethylene can be used for the material of the sheath 33. The sheath 33 suppresses direct contact between the core portion 32 and the wires 20, and has the function of protecting the wires 20. The sheath 33 is made of a material that is different from that of the core portion 32, and is provided separately from the core portion 32.

The holders 35 are formed on the outer circumferential surface of the axial portion 31 (specifically, the sheath 33). A plurality of (two in this embodiment) holders 35 are formed, for example, on the outer circumference of the axial portion 31 in a circumferential direction of the axial portion 31 at predetermined intervals. For example, two holders 35 are formed on the outer circumference of the axial portion 31 at equal angular intervals (180 degrees in this embodiment) in the circumferential direction of the axial portion 31. The holders 35 are formed so as to protrude outward from the outer circumferential surface of the axial portion 31 (specifically, the sheath 33), for example, in a direction (i.e., in a radial direction) perpendicular with respect to the axial direction of the axial portion 31 (an extending direction). In this embodiment, two holders 35 are formed so as to protrude in opposite directions to each other about the axial portion 31. In other words, in the route-regulating member 30 in this embodiment, the core portion 32 whose bending rigidity is higher than that of the outer cover member 50 is formed to be positioned at the center of the route-regulating member 30. The holders 35 are each provided to hold one wire 20.

The holders 35 are each constituted of a plurality of (four in FIG. 3) fitting portions 36, for example. The fitting portions 36 are provided in the axial direction of the axial portion 31 at predetermined intervals. That is, the fitting portions 36 are lined up at predetermined intervals along the routes where the wires 20 are routed. The fitting portions 36 are not provided on the bent portions 31R of the axial portion 31, for example. Moreover, the fitting portions 36 are not provided on the bent portions 31R and the straight portion 31S of the axial portion 31, whose axial direction extends along the intermediate route R3, for example. In other words, the fitting portions 36 are provided only on the straight portions S1 and S2 of the axial portion 31.

The fitting portions 36 are each formed so as to protrude outward from the outer circumferential surface of the axial portion 31 (specifically, the sheath 33) in the radial direction of the axial portion 31. Midway portions of the wires 20 in the direction in which the wires 20 extend (axial direction) are attached to the fitting portions 36.

As shown in FIG. 2, the fitting portions 36 have an annular structure conforming to the outer circumferential shape of the wires 20, for example. The annular structure of each of the fitting portions 36 in this embodiment has a C-shape, for example. Specifically, the annular structure of each of the fitting portions 36 includes an inner circumferential surface having a circular shape for holding the wire 20, which has a circular outer circumferential surface and which is fitted to it. The annular structure of each of the fitting portions 36 includes an insertion portion 37 into which the wires 20 can be inserted in a radial direction of the annular structure. That is, the annular structure of each of the fitting portions 36 is a noncontinuous annular structure, and includes a first end portion 36A and a second end portion 36B that is spaced apart from the first end portion 36A. The insertion portion 37 is positioned apart from the outer circumferential surface of the axial portion 31. For example, the insertion portion 37 is positioned mostly apart from the outer circumferential surface of the axial portion 31 in the fitting portion 36.

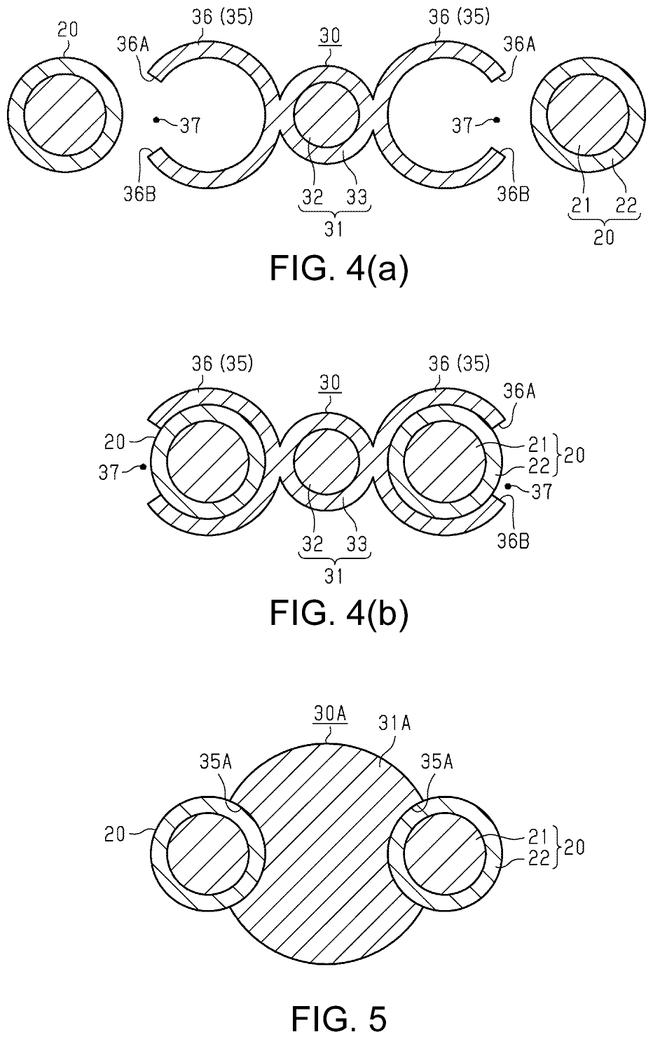

As shown in FIG. 4, the annular structure of each of the fitting portions 36 is configured to be deformable between an insertion posture where the wires 20 can be inserted from the insertion portions 37 between the first end portion 36A and the second end portion 36B (see FIG. 4(a)) and an attachment posture where the fitting portions 36 are attached to the wires 20 (see FIG. 4(b)). Here, in the annular structure of each of the fitting portions 36, a gap between the first end portion 36A and the second end portion 36B (i.e., the width of the insertion portion 37) is set to be equal to or smaller than the diameter of the wire 20. In addition, the annular structure of each of the fitting portions 36 is formed to be elastically deformable by enlarging the gap between the first end portion 36A and the second end portion 36B.

Synthetic resin such as polyolefin, polypropylene, polyamide, polyester, and polyethylene can be used for the material of the fitting portions 36. The fitting portions 36 may be made of the same material as or a material different from that of the sheath 33 of the axial portion 31. The fitting portions 36 in this embodiment are made of the same material as the sheath 33, and are formed integrally with the sheath 33. That is, the sheath 33 and the fitting portions 36 are formed integrally as an integrated component.

As shown in FIG. 2, the route-regulating member 30 is arranged in a space inside of the outer cover member 50 made of resin while each of the holders 35 holds one wire 20 fitted to them. The route-regulating member 30 is provided in the space inside of the outer cover member 50 in such a manner that the core portion 32 is arranged at the center in the radial direction of this inner space. As shown in FIG. 2, the route-regulating member 30 may be configured to hold the wires 20 in such a manner that a plurality of central axes of the wires 20 and a central axis of the axial portion 31 of the route-regulating member 30 are lined up next to each other on a common virtual plane. The route-regulating member 30 in FIG. 2 brings the effect that it is possible to reduce the height of an assembly made of the wires 20 and the route-regulating member 30.

Moreover, the route-regulating member 30 according to this embodiment holds the wires 20 with use of the holders 35 only, and thus uses no fixing member (e.g., an adhesive tape or a cable tie) other than the holders 35 for holding the wires 20.

The following describes one example of a method of manufacturing the wire harness 10.

Firstly, the wires 20 are attached to the holders 35 of the route-regulating member 30. Specifically, when the wires 20 are inserted into the insertion portions 37 of the fitting portion 36 whose dimension is smaller than the diameter of the wires 20 as shown in FIG. 4(a), the fitting portions 36 are elastically deformed in such a manner that the gap between the first end portion 36A and the second end portion 36B is widened temporarily (not shown) in the annular structure of the fitting portions 36. Then, when the wires 20 pass through the insertion portions 37 and are fitted inside the fitting portions 36 as shown in FIG. 4(b), the annular structure of the fitting portions 36 elastically returns to its original shape, that is, elastically returns so as to narrow the gap between the first end portion 36A and the second end portion 36B. That is, the fitting portions 36 and the wires 20 form a snap-fit structure, using elastic deformation to prevent the wires 20 from coming off.

At this time, the fitting portions 36 include the insertion portions 37 formed therein into which the wires 20 can be inserted in the radial direction of the annular structure of the fitting portions 36. Accordingly, even after one of the wires 20 is attached to one of the holders 35, the middle portion of the other wire 20 is attachable to the other holder 35 by inserting the other wire 20 into the fitting portions 36 of the other holder 35 along the radial direction.

Thereafter, the route-regulating member 30 and the wires 20 are inserted into the outer cover member 50. At this time, an electromagnetic shielding component 40 is provided inside the outer cover member 50, enclosing the route-regulating member 30 and the wires 20 collectively.

Then, bending processing is performed on the outer cover member 50, causing the outer cover member 50 to be deformed in a desired shape along the routes where the wires 20 are routed. At this time, the route-regulating member 30, the wires 20, and the electromagnetic shielding component 40 disposed inside the outer cover member 50 are deformed together with the outer cover member 50 in the desired shape so as to conform to the routes where the wires 20 are routed. That is, in this embodiment, the outer cover member 50 as well as the route-regulating member 30, the wires 20, and the electromagnetic shielding component 40 disposed inside the outer cover member 50 are deformed in a shape along the first straight route R1, the intermediate route R3, and the second straight route R2.

Next, functions and effects of this embodiment will be described.

(1) The route-regulating member 30 is provided inside the outer cover member 50 made of resin. The route-regulating member 30 has bending rigidity higher than that of the outer cover member 50. Since the route-regulating member 30 functions as a core member, the outer cover member 50 made of resin can be kept in a desired shape along the routes where the wires 20 are routed.

For example, when bending processing is performed on a hard resin pipe (the outer cover member 50), the resin pipe tends to return from a bent shape (a curved shape) to its original shape (a straight shape) after time passes from the bending processing, due to the material properties of resin. In contrast to this, in the wire harness 10 in this embodiment, the route-regulating member 30 whose bending rigidity is higher than that of the outer cover member 50 is provided inside the outer cover member 50, which is a resin pipe. Consequently, deformation of the outer cover member 50 is regulated by the route-regulating member 30 when the outer cover member 50 returns from its bent shape to its straight shape. Accordingly, the outer cover member 50 made of resin can be kept in a desired shape along the routes where the wires 20 are routed.

Moreover, a corrugated tube (the outer cover member 50) having excellent flexibility tends to bend if laid out in a straight route, making it difficult to keep its the shape straight. In contrast to this, in the wire harness 10 in this embodiment, the route-regulating member 30 serving as the core member is provided inside the outer cover member 50. Consequently, deformation (e.g., bending) of the outer cover member 50 is regulated (restricted) by the route-regulating member 30. Accordingly, the outer cover member 50 made of resin can be kept in a desired shape along the routes where the wires 20 are routed.

(2) The holders 35 configured to hold the wires 20 fitted to them are provided on the route-regulating member 30. Accordingly, fitting the wires 20 into the holders 35 enables attachment of the wires 20 to the route-regulating member 30. As a result, the wires 20 can be attached to the route-regulating member 30 without using any fixing member (e.g., an adhesive tape or a cable tie) as a component separated from the route-regulating member 30.

(3) The axial portion 31 of the route-regulating member 30 is constituted of the core portion 32 whose bending rigidity is higher than that of the outer cover member 50, and the sheath 33 made of resin and configured to cover the outer circumferential surface of the core portion 32. With this configuration, the outer circumferential surface of the core portion 32 is covered with the sheath 33 made of resin, suppressing direct contact of the end portion of the metallic core portion 32 to the insulating sheath 22 of the wire 20. Consequently, even when the wires 20 sway due to vibration when driving the vehicle after the wire harness 10 is assembled to the vehicle body, for example, damages to the insulating sheath 22 caused by corners at the end portion of the core portion 32 can be suppressed. This enables enhanced durability of the wire harness 10.

(4) The holders 35 are formed on the outer circumferential surface of the axial portion 31, protruding outward in the direction perpendicular with respect to the axial direction of the axial portion 31. Moreover, the holders 35 are formed on the outer circumference of the axial portion 31 at equal angular intervals in the circumferential direction of the axial portion 31. With this configuration, the core portion 32 serving as the core member can be arranged around the center of the route-regulating member 30.

(5) The sheath 33, which is made separately from the core portion 32, is formed integrally with the holders 35. In other words, the core portion 32 and the holders 35 are formed separately. This makes it possible to set the shapes of the core portion 32 and the holders 35 individually. Accordingly, a configuration can be employed, for example, where the holders 35 are not set in a specific route (e.g., the intermediate route R3 including the curved routes RC).

(6) Now, when the outer cover member 50, the route-regulating member 30, and the wires 20 are subjected to the bending processing, the fitting portions 36 of the route-regulating member 30 may hamper the bending processing at the bent portions.

To avoid this, with this embodiment, the part of the route-regulating member 30 that regulates the curved routes RC of the routes where the wires 20 are routed is formed only by the axial portion 31 and is not provided with any fitting portions 36. This makes it possible to avoid hampering of the bending processing to the outer cover member 50, the axial portion 31 of the route-regulating member 30, and the wires 20 while the shape of the outer cover member 50 is kept with the axial portion 31 (especially, the core portion 32).

(7) One wire 20 is held on one holder 35. Accordingly, a plurality of wires 20 are held by different holders 35 when the wires 20 are attached to the route-regulating member 30. Thus, the route-regulating member 30 regulates the relative positional relationship among the wires 20. As a result, placement positions (arrangement) of the wires 20 inside the outer cover member 50 can be kept favorably.

### Other Embodiments

The embodiment described above can be modified as follows. The embodiment described above and following modifications may be combined to the extent that they do not contradict to each other technically.

In the embodiment described above, the part of the route-regulating member 30 that regulates the intermediate route R3 is formed only by the axial portion 31 and is not provided with any fitting portions 36. However, there is no limitation to this. Alternatively, the parts of the route-regulating member 30 that regulate only the curved routes RC of the intermediate route R3 may be formed only by the axial portion 31. That is, the fitting portions 36 may also be provided on only that part of the route-regulating member 30 that regulates the straight route of the intermediate route R3 (i.e., the straight portion 31S of the axial portion 31).

Moreover, the fitting portions 36 may be provided also on those parts of the route-regulating member 30 that regulate the curved routes RC (i.e., the bent portions 31R of the axial portion 31).

In the above-described embodiment, four fitting portions 36 form one holder 35, but the number of fitting portions 36 is not limited particularly.

The fitting portions 36 are occasionally referred to as fingers. The shape of the fitting portions 36 in the embodiment described above is not particularly limited to the shape shown in FIGS. 2 and 3. The shape of the fitting portions 36 is not particularly limited as long as the fitting portions 36 enable holding of the wires 20 fitted to them.

The material of the core portion 32 in the embodiment described above is not limited to a metallic material as long as the material has a bending rigidity that is higher than that of the outer cover member 50.

In the embodiment described above, the holders 35 and the sheath 33 are formed integrally. Alternatively, the holders 35 and the sheath 33 may also be formed separately.

In the embodiment described above, the holders 35 and the core portion 32 (the axial portion 31) are formed separately. Alternatively, the holders 35 and the core portion 32 (the axial portion 31) may also be formed integrally.

For example, as shown in FIG. 5, a route-regulating member 30A may also be formed as one component. The route-regulating member 30A has an axial direction extending along the route where wires 20 are routed, and includes an axial portion 31A whose bending rigidity is higher than that of an outer cover member 50. The axial portion 31A in this embodiment is formed in a substantially cylindrical shape. A plurality of (two in this embodiment) holders 35A are formed on an outer circumferential surface of the axial portion 31A at predetermined intervals (180 degrees in this embodiment) in the circumferential direction of the axial portion 31A, for example. The holders 35A are grooves recessed inward from the outer circumferential surface of the axial portion 31A in a radial direction of the axial portion 31A. The holders 35A are formed so as to extend continuously along the axial direction of the axial portion 31A (i.e., in the direction in which the axial portion 31A extends). The holders 35A are formed integrally with the axial portion 31A. The holders 35A can hold the wires 20 fitted to them.

The axial portion 31A is made of a material that has sufficient rigidity to maintain the shape of the outer cover member 50. The axial portion 31A is preferably made of a material that is plastically deformable from the viewpoint of making it possible to set the route through bending processing. For example, a metallic material is favorably used as the material of the axial portion 31A. A metallic material such as a copper-based material, an iron-based material, or an aluminum-based material can be used as the metallic material.

A sheath made of resin and configured to cover surfaces of the axial portion 31A and the holders 35A may be formed in the route-regulating member 30A shown in FIG. 5.

In the above-described embodiment, the holders 35 are each configured such that one wire 20 is fitted into one holder 35. Alternatively, the holders 35 may also be formed such that a plurality of wires 20 are fitted into one holder 35.

The wires 20 may also be fixed to the route-regulating member 30 via a fixing member different from the route-regulating member 30 while the wires 20 are held in the holders 35 of the route-regulating member 30 in the embodiment described above. An adhesive tape or a cable tie can be used as such a fixing member.

In the embodiment described above, non-shielded wires are used as the wires 20, but the types of wires 20 are not limited to this. For example, shielded wires having a shielding structure therein may also be used as the wires 20. In this case, the electromagnetic shielding component 40 may be omitted.

In the above-described embodiment, the wire harness 10 has an electromagnetic shielding function. However, a wire harness 10 without any electromagnetic shielding function may also be used instead.

In the above-described embodiment, two wires 20 are inserted into the outer cover member 50. However, there is no limitation to such a configuration, and the number of wires 20 can be changed in accordance with the specification of the vehicle. For example, the number of wires 20 inserted into the outer cover member 50 may also be one or three or more. For example, low-voltage electrical wires that connect a low-voltage battery and various low-voltage devices (e.g., a lamp and a car audio device) may be added as wires that are inserted into the outer cover member 50.

The positional relationship between the inverter 11 and the high-voltage battery 12 in the vehicle is not limited to that in the above-described embodiment, and may be changed as appropriate in accordance with the configuration of the vehicle.

In the above-described embodiment, the inverter 11 and the high-voltage battery 12 are adopted for electric apparatuses connected to the wires 20. However, there is no limitation to this. The present disclosure is also applicable to wires that connect the inverter 11 and a wheel driving motor, for example. That is, it can be applied to any component that electrically connects electric apparatuses installed in the vehicle.

The present disclosure encompasses the following implementation examples. Not for limitation but for assistance in understanding, the reference numerals of the representative components in the representative embodiment are provided.

[APPENDIX 1] The wire harness (10) according to a non-limited embodiment may include a plurality of wires (20) routed in predetermined wiring routes (R1, R2, R3, RC), and a route-regulating member (30) configured to regulate shapes of predetermined lengths of the wires (20) in such a manner that the wires (20) conform to shapes of the predetermined wiring routes (R1, R2, R3, RC),

the route-regulating member (30) may include a long core (32) having an elongated shape conforming to the predetermined wiring routes (R1, R2, R3, RC), and a plurality of fingers (36) supported on the long core (32), and

the fingers (36) may be configured to directly contact outer surfaces of the predetermined lengths of the wires (20) to hold the wires (20) parallel to the long core (32).

[APPENDIX 2] The fingers (36) may be formed as a plurality of pairs of fingers (36), and each pair of fingers (36) may be configured so as to elastically clamp one of the wires (20).

[APPENDIX 3] The pairs of fingers (36) may be disposed at intervals in a longitudinal direction of the long core (32).

[APPENDIX 4] The pairs of fingers (36) may be configured to hold the wires (20) in such a manner that a plurality of central axes of the wires (20) and a central axis of the long core (32) of the route-regulating member (30) are lined up on a common virtual plane.

[APPENDIX 5] The pairs of fingers (36) may include first paired fingers (36) and second paired fingers (36), the first paired fingers (36) protruding from a first region on the outer surface of the long core (32) at a first position in the longitudinal direction of the long core (32) outward in a radial direction, and the second paired fingers (36) protruding from a second region at the first position in the longitudinal direction of the long core (32) outward in the radial direction, the second region being shifted from the first region circumferentially by 180 degrees on the outer surface of the long core (32).

It will be apparent to those skilled in the art that the present disclosure may be embodied in other specific forms without departing from the technical concept of the disclosure. For example, some of the components described in the embodiments (or one or more aspects thereof) may be omitted, or some of the components may be combined. The scope of the present disclosure should be determined with reference to the appended claims, along with the full scope of equivalents to which such claims are entitled.

1. A wire harness, comprising:
a wire;
a route regulator having an axial direction extending along a route where the wire is routed, the route regulator including a holder configured to hold the wire fitted to the holder, and configured to regulate the route where the wire is routed; and
an outer cover made of resin and configured to accommodate the wire and the route regulator,
the route regulator having a bending rigidity that is higher than a bending rigidity of the outer cover.

2. The wire harness according to claim 1, wherein
the route regulator includes an axial portion extending in the axial direction, and
the axial portion includes a core whose bending rigidity is higher than the bending rigidity of the outer cover, and a sheath made of resin and configured to cover an outer circumferential surface of the core.

3. The wire harness according to claim 2, wherein the holder is formed on an outer circumferential surface of the axial portion, protruding outward in a direction perpendicular with respect to the axial direction.

4. The wire harness according to claim 3, wherein the holder includes a plurality of holders formed on an outer circumference of the axial portion at equal angular intervals in a circumferential direction of the axial portion.

5. The wire harness according to claim 2, wherein the holder and the sheath are formed integrally as an integrated component.

6. The wire harness according to claim 2, wherein the holder is formed by a plurality of fitting portions each into which the wire is fitted and that are configured to be provided at predetermined intervals in the axial direction of the axial portion.

7. The wire harness according to claim 6, wherein:
the route where the wire is routed includes straight routes and a curved route, and
a part of the route regulator that regulates the curved route is not provided with the fitting portions, and is formed only by the axial portion.

8. The wire harness according to claim 1, wherein the outer cover is a hard resin pipe.

9. The wire harness according to claim 1, wherein the outer cover is formed so as to enclose the route regulator entirely.

10. The wire harness according to claim 1, wherein the outer cover includes therein an electromagnetic shielding component configured to enclose the wire and the route regulator.
